(19) United States
(12) Patent Application Publication
(10) Pub. No.: US 2026/0127764 A1
(43) Pub. Date: May 7, 2026

(54) INFORMATION PROCESSING APPARATUS, INFORMATION PROCESSING METHOD, AND NON-TRANSITORY COMPUTER-READABLE MEDIUM

(71) Applicant: SONY GROUP CORPORATION, Tokyo (JP)

(72) Inventors: Yosuke KONNO, Tokyo (JP); Jun GOMITA, Tokyo (JP); Massaya KANEKO, Chiba (JP)

(73) Assignee: SONY GROUP CORPORATION, Tokyo (JP)

(21) Appl. No.: 19/117,398

(22) PCT Filed: Feb. 9, 2024
(86) PCT No.: PCT/JP2024/004669

§ 371 Date: Apr. 1, 2025

(30) Foreign Application Priority Data
Mar. 15, 2023 (JP) 2023-040879

(51) Int. Cl. G06T 7/80; G06T 7/00

(52) U.S. Cl. CPC G06T 7/80; G06T 7/97; G06T 2207/10004; G06T 2207/10048; G06T 2207/30204

(57) ABSTRACT

An information processing apparatus including circuitry configured to obtain at least one first image of a display screen, the at least one first image being acquired by a first camera, obtain at least one second image of at least one marker in an imaging space around the display screen, the at least one second image being acquired by a second camera, estimate first position information of the first camera in relation to the display screen based on the at least one first image, obtain offset information between the first camera and the second camera, and estimate second position information of the second camera and third position information of the at least one marker in relation to the display screen based on the first position information, the at least one second image, and the offset information, wherein a positional relation between the first camera and the second camera is fixed.

### CROSS REFERENCE TO RELATED APPLICATIONS

This application claims the benefit of Japanese Priority Patent Application JP 2023-040879 filed on Mar. 15, 2023, the entire contents of which are incorporated herein by reference.

### TECHNICAL FIELD

The present disclosure relates to an information processing apparatus, an information processing method, and a non-transitory computer-readable medium.

### BACKGROUND ART

A technique for estimating a three-dimensional structure of a predetermined subject from a plurality of two-dimensional images including the subject is known. The above-described technique includes, for example, a technique called structure from motion (SfM) described in NPL 1.

### CITATION LIST

### Non Patent Literature

NPL 1: Roger Mohr and two others, “Relative 3D Reconstruction Using Multiple Uncalibrated Images”, The International Journal of Robotics Research, SAGE Publications, 1995, 14 (6), pp. 619-632. Dec. 1, 1995

### SUMMARY

### Technical Problem

Furthermore, there is a case where a three-dimensional position of a marker used in estimation of the position and orientation of a camera is estimated by SfM. In such a case, calibration is required each time the position of the marker is moved, which causes a concern about an increase in processing time.

### Solution to Problem

According to the present disclosure, there is provided an information processing apparatus that includes circuitry configured to obtain at least one first image of a display screen, the at least one first image being acquired by a first camera, obtain at least one second image of at least one marker in an imaging space around the display screen, the at least one second image being acquired by a second camera, estimate first position information of the first camera in relation to the display screen based on the at least one first image, obtain offset information between the first camera and the second camera, and estimate second position information of the second camera and third position information of the at least one marker in relation to the display screen based on the first position information, the at least one second image, and the offset information, wherein a positional relation between the first camera and the second camera is fixed.

Furthermore, according to the present disclosure, there is provided an information processing method that includes obtaining at least one first image of a display screen, the at least one first image being acquired by a first camera, obtaining at least one second image of at least one marker in an imaging space around the display screen, the at least one second image being acquired by a second camera, estimating first position information of the first camera in relation to the display screen based on the at least one first image, obtaining offset information between the first camera and the second camera, and estimating second position information of the second camera and third position information of the at least one marker in relation to the display screen based on the first position information, the at least one second image, and the offset information, wherein a positional relation between the first camera and the second camera is fixed.

In addition, according to the present disclosure, there is provided a non-transitory computer-readable medium having embodied thereon a program, which when executed by a computer causes the computer to function as execute an information processing method, the method including obtaining at least one first image of a display screen, the at least one first image being acquired by a first camera, obtaining at least one second image of at least one marker in an imaging space around the display screen, the at least one second image being acquired by a second camera, estimating first position information of the first camera and third position information of the at least one marker in relation to the display screen based on the at least one first image, obtaining offset information between the first camera and the second camera, and estimating second position information of the second camera and third position information of the at least one marker in relation to the display screen based on the first position information, the at least one second image, and the offset information, wherein a positional relation between the first camera and the second camera is fixed.

### BRIEF DESCRIPTION OF DRAWINGS

FIG. 1 is a diagram for describing an outline of an information processing system according to the present disclosure.

FIG. 2 is an explanatory diagram for describing an example of a functional configuration of an information processing apparatus 20 according to the present disclosure.

FIG. 3 is an explanatory diagram for describing an outline of a calibration process of the information processing system.

FIG. 4A is an explanatory diagram for describing details relating to correction of a local coordinate system.

FIG. 4B is an explanatory diagram for describing details relating to the correction of the local coordinate system.

FIG. 4C is an explanatory diagram for describing details relating to the correction of the local coordinate system.

FIG. 5 is an explanatory diagram for describing a procedure of calibration relating to mount offset estimation.

FIG. 6 is an explanatory diagram for describing an example of processing of generating a map with pose priors.

FIG. 7 is an explanatory diagram for describing an example of overall processing performed by the information processing apparatus 20 according to the present disclosure.

FIG. 8 is an explanatory diagram for describing an example of mount offset estimation processing performed by the information processing apparatus 20 according to the present disclosure.

FIG. 9 is an explanatory diagram for describing a modification of the information processing system according to the present disclosure.

FIG. 10 is a block diagram illustrating a hardware configuration example of an information processing apparatus 90 according to an embodiment of the present disclosure.

### DESCRIPTION OF EMBODIMENTS

A preferred embodiment of the present disclosure will now be described in detail with reference to the accompanying drawings. Note that, in the present specification and the drawings, components having substantially the same functional configurations are denoted by the same reference numerals, and redundant descriptions are omitted.

Note that the description will be given in the following order.
1. Embodiment
1.1. Outline
1.2. Configuration example
1.3 Details
2. Example of operation processing
3. Modification
4. Hardware configuration example
5. Conclusion

### 1. Embodiment

### 1.1. Outline

As described above, there is a case where the processing result of the SfM is used in estimation of the position and orientation of a camera.

As an example, at the site of video production, it is often required to track the position and orientation of the camera in real time for visual effects (VFX) or the like.

Techniques for real-time tracking of the position and orientation of the camera as described above include a technique for tracking, with a plurality of markers (hereinafter, referred to as IR markers) each including a retroreflective material or the like arranged in an imaging space, the markers using an infrared (IR) camera to obtain the position and orientation of the IR camera.

While the above-described technique allows estimation at low cost and in a robust manner, the technique has a problem that calibration of the markers takes a lot of time and effort.

Furthermore, a studio in which a display device such as a light-emitting diode (LED) panel is arranged on a wall or the like in an imaging space for virtual production (VP) is now available. In a case where VP is performed in such a studio, there is a case where an IR camera that performs real-time tracking of the position and orientation of a cinema camera for capturing an image of a subject adjacent to the LED panel is attached to the cinema camera. Such a system that causes the IR camera to perform real-time tracking of the position and orientation of the cinema camera is referred to as tracking system.

Furthermore, in the VP, the display device displays a computer graphics (CG) image adapted to the position and orientation of the cinema camera. In order to reflect the position and orientation of the cinema camera in the CG image, it is necessary to make a coordinate system of the CG space and a coordinate system of the tracking system common to each other. As a possible example, each coordinate system of the tracking system is unified to the coordinate system of the CG space.

In order to make the coordinate system of the CG space and the coordinate system of the tracking system common to each other, three independent calibration processes may be required as an initial configuration. According to a comparative example, as the initial configuration, calibration relating to map generation (first process) is first performed, then calibration relating to mount offset estimation (second process) is performed, and calibration relating to LED volume alignment (third process) is finally performed.

The map generation is a calibration process of restoring a three-dimensional position of the IR marker in the imaging space and estimating a physical scale. A technique for map generation according to the comparative example may require a user to perform an initialization operation in order to start the map generation in a stable manner. For example, the user holds a tracking camera and horizontally moves the tracking camera by a distance of about 10% of an installation height (approximate value) of the IR marker to obtain the physical scale while allowing viewpoint changes enough for the start of the map generation. Furthermore, to achieve more accurate horizontal movement, the user may also need to install a guide in advance by means of marking or the like.

The mount offset estimation is a calibration process of estimating a coordinate system offset between the cinema camera and the tracking camera. In a technique for the mount offset estimation according to the certain comparative example, there is a case where a value calculated on the basis of an actual measurement value or a CAD design value is manually set. Specifically, a typical cinema camera has a sensor position imprinted on its body, so that the user calculates an offset in accordance with the position where the tracking camera is attached to the cinema camera, and manually sets the calculated value. Such a method for manually setting a mount offset, however, is troublesome for the user, and tends to cause a setting error due to human error or the like.

The LED volume alignment is a calibration process of making the coordinate system of the CG space (hereinafter, also referred to LED coordinate system) and the coordinate system of the tracking system common to each other. In a technique for the LED volume alignment according to the comparative example, the user manually defines the LED coordinate system using a marking tool or the like on a physical space, and sets three reference points in the defined LED coordinate system. Then, the user performs alignment using coordinate values of the LED coordinate system corresponding to an output pose when the tracking camera is arranged at each reference point. It takes a lot of time to physically set such an LED coordinate system. Moreover, the alignment is performed not on the basis of information actually displayed on the LED panel, so that an error is prone to occur. Furthermore, in the end, a process of causing the user to manually perform a fine adjustment to a translational position and a rotational position to balance the error is required, and this process also requires a certain time and effort. In some situations, the user may need to perform the calibration process again from the map generation process (first process).

The three calibration processes as described above have a problem that it takes a lot of time and effort. For example, in a case of a studio having a general size, it is not unusual that the three calibration processes take about 2 to 3 hours.

Moreover, there may be a demand to move the position of the marker in accordance with an imaging scene, but this also requires a calibration process that takes a lot of time.

It may be difficult to cause a performer or an imaging staff to stand by during the calibration process that takes a long time from the viewpoint of cost and the like, and as a result, it is not unusual that the range of the imaging method is limited.

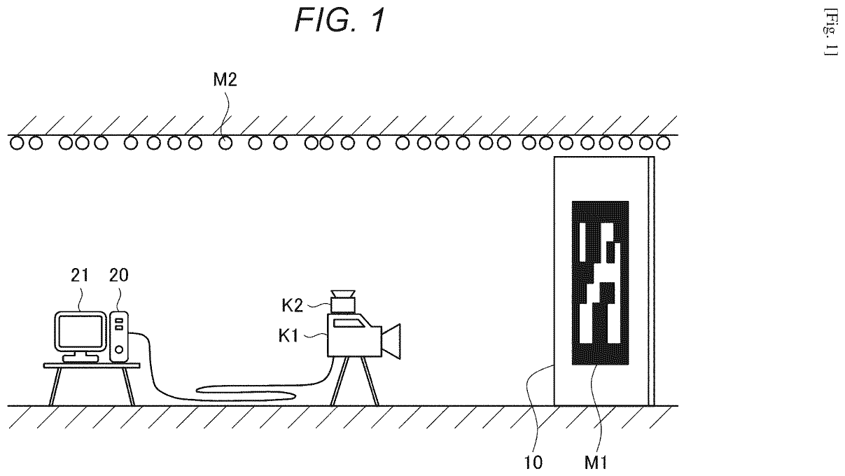

The technical idea according to the present disclosure has been conceived of by focusing on the above points, and allows a reduction in time required for the above-described calibration process. First, an outline of an information processing system according to an embodiment of the present disclosure will be described with reference to FIG. 1.

FIG. 1 is a diagram for describing the outline of the information processing system according to the present disclosure. As illustrated in FIG. 1, the information processing system according to the present disclosure includes an LED panel 10, a cinema camera K1, a tracking camera K2, and an information processing apparatus 20.

### (LED Panel 10)

The LED panel 10 according to the present disclosure is an example of a display device, and displays an augmented reality (AR) marker M1 during calibration as illustrated in FIG. 1. Furthermore, the LED panel 10 displays a CC image. For example, the LED panel 10 displays a CG image based on the position and orientation of the cinema camera K1 in an AR marker coordinate system.

Note that FIG. 1 illustrates an example where the LED panel 10 displays one AR marker M1, but in practice, the LED panel 10 according to the present disclosure displays a plurality of the AR markers M1. Furthermore, a coordinate value of a coordinate system (hereinafter, referred to as AR marker coordinate system) in the LED panel 10 is defined for each of the plurality of AR markers M1. Note that the AR marker M1 need not necessarily be displayed on the LED panel 10, and may be provided as, for example, a printed matter or the like. In this case, it is necessary to achieve conversion between the coordinate system of the CG image and the coordinate system of the AR marker M1 by some other method.

### (Cinema Camera K1)

The cinema camera K1 according to the present disclosure is an example of a first camera, and is a camera that captures an image of a subject adjacent to the LED panel 10. For example, the cinema camera K1 captures an image of the AR marker M1 displayed on the LED panel 10 during calibration.

Furthermore, the cinema camera K1 captures an image of the subject including the CG image displayed on the LED panel 10. Note that the information processing system according to the present disclosure may include another camera capable of capturing an image of the AR marker M1 instead of the cinema camera K1.

### (Tracking Camera K2)

The tracking camera K2 according to the present disclosure is an example of a second camera, and is a camera attached to the cinema camera K1. For example, the tracking camera K2 includes an element capable of capturing an image of infrared light, and captures an image of IR markers M2 arranged on a ceiling in an imaging space. Note that the ceiling in the imaging space is an example of a wall in the space.

The IR markers 1M2 are irregularly arranged on the ceiling in the imaging space. Furthermore, each IR marker M2 may be a retroreflective material, or may be a light or the like that can itself emit infrared light.

Note that, in the following description, an example where the IR markers M2 are arranged on the ceiling in the imaging space will be mainly described, but the position of each IR marker M2 is not particularly limited as long as the IR markers M2 are arranged so as to surround the tracking camera K2 in the imaging space. For example, the IR markers M2 may be arranged on a floor or a side wall in the imaging space.

### (Information Processing Apparatus 20)

The information processing apparatus 20 according to the present disclosure is an apparatus that performs various types of calibration processing. The information processing apparatus 20 may be, for example, a personal computer (PC) as illustrated in FIG. 1, or may be another information terminal such as a tablet terminal or a smartphone.

The information processing apparatus 20 acquires relative position information regarding relative positions of the cinema camera K1 and the tracking camera K2, for example.

Furthermore, the information processing apparatus 20 estimates various ypes of position information of the cinema camera K1, the tracking camera K2, and the IR marker M2 in the AR marker coordinate system on the basis of image data obtained as a result of capturing an image of the AR marker M1 by the cinema camera K1, image data obtained as a result of capturing an image of the IR marker M2 by the tracking camera K2, and the relative position information of the cinema camera K1 and the tracking camera K2. The position information here may include information regarding a position and orientation. A detailed configuration of the information processing apparatus 20 according to the present disclosure will be described later.

Furthermore, the information processing apparatus 20 may output various types of information regarding the calibration processing to a display unit 21. For example, the user may check a calibration result displayed on the display unit 21.

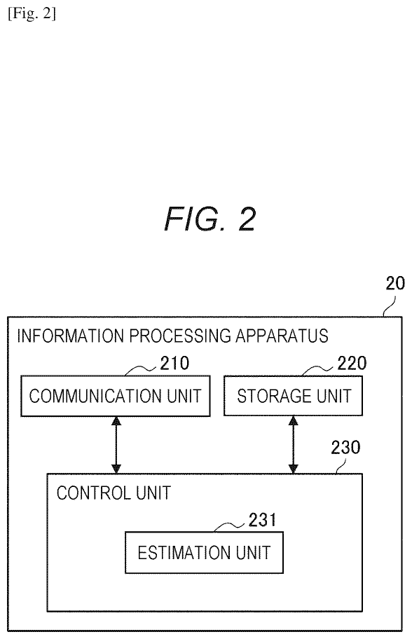

The outline of the information processing system according to the present disclosure has been described above. Next, a functional configuration example of the information processing apparatus 20 according to the present disclosure will be described with reference to FIG. 2.

### 1.2. Configuration Example

FIG. 2 is an explanatory diagram for describing an example of a functional configuration of the information processing apparatus 20 according to the present disclosure. As illustrated in FIG. 2, the information processing apparatus 20 according to the present disclosure includes a communication unit 210, a storage unit 220, and a control unit 230.

### (Communication Unit 210)

The communication unit 210 according to the present disclosure performs various types of communication with the cinema camera K1 and the tracking camera K2. For example, the communication unit 210 receives, from the cinema camera K1, the image data obtained as a result of capturing an image of the AR marker M1 by the cinema camera K1. Furthermore, the communication unit 210 receives, from the tracking camera K2, the image data obtained as a result of capturing an image of the IR marker M2 by the tracking camera K2.

Note that either the cinema camera K1 or the tracking camera K2 may output the image data acquired by itself to the other camera. In this case, the communication unit 210 may receive both of the image data obtained as a result of capturing an image of the AR marker M1 by the cinema camera K1 and the image data obtained as a result of capturing an image of the IR marker M2 by the tracking camera K2 from either the cinema camera K1 or the tracking camera K2.

### (Storage Unit 220)

The storage unit 220 according to the present disclosure holds software and various data. For example, the storage unit 220 holds various types of image data received by the communication unit 210. Furthermore, the storage unit 220 may hold various types of information such as image data, an identification (ID) of the image data, an ID of each IR marker N2, a coordinate value of the IR marker N12 in the image data, an ID of the AR marker M1, a coordinate value of the AR marker M1, or position information of the tracking camera K2 corresponding to the image data. Moreover, the storage unit 220 may hold observation values of other types of sensors such as an inertial measurement unit (IMU).

### (Control Unit 230)

The control unit 230 according to the present disclosure controls the overall operation of the information processing apparatus 20. For example, the control unit 230 controls transmission and reception of various types of information by the communication unit 210. Furthermore, as illustrated in FIG. 2, the control unit 230 includes an estimation unit 231.

### {Estimation Unit 231}

The estimation unit 231 according to the present disclosure is an example of an acquisition unit, and estimates the relative position information of the cinema camera K1 and the tracking camera K2.

Furthermore, the estimation unit 231 is an example of a first estimation unit, and estimates position information of the cinema camera K1 in the AR marker coordinate system on the basis of the image data obtained as a result of capturing by the cinema camera K1, an image of the AR marker M1 displayed by the LED panel 10.

Furthermore, the estimation unit 231 is an example of a second estimation unit, and estimates position information of the IR marker M2 and the tracking camera K2 in the AR marker coordinate system on the basis of the image data obtained as a result of capturing, by the tracking camera K2, an image of the IR marker M2 arranged on the ceiling in the imaging space, the relative position information of the cinema camera K1 and the tracking camera K2, and the position information of the cinema camera K1 in the AR marker coordinate system. Details of various types of processing performed by the estimation unit 231 will be described later.

The functional configuration example of the information processing apparatus 20 according to the present embodiment has been described above. Note that the functional configuration described above with reference to FIG. 2 is merely an example, and the functional configuration of the information processing apparatus 20 according to the present embodiment is not limited to such an example.

For example, the storage unit 220 according to the present disclosure may be provided in an apparatus separate from the information processing apparatus 20. Furthermore, the information processing apparatus 20 according to the present embodiment may further include, for example, an operation unit or the like that receives user operation.

Furthermore, some of the functions of the estimation unit 231 included in the information processing apparatus 20 may be implemented by another apparatus. For example, the cinema camera K1 or the tracking camera K2 may have a functional configuration to estimate the relative position information of the cinema camera K1 and the tracking camera K2. In this case, the communication unit 210 corresponds to an acquisition unit that acquires the relative position information from the cinema camera K1 or the tracking camera K2. Furthermore, another apparatus (for example, a server or the like) may have a functional configuration corresponding to the first estimation unit or the second estimation unit.

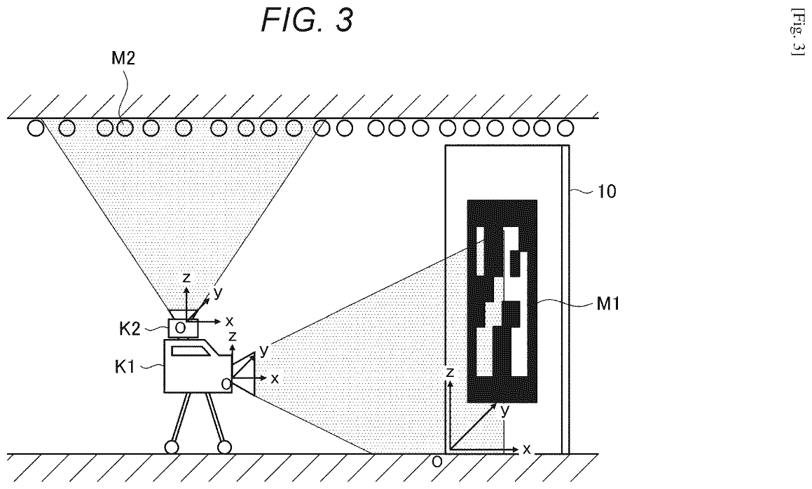

The functional configuration of the information processing apparatus 20 according to the present disclosure can be flexibly modified according to specifications, operations, or the like. Next, details of various types of processing performed by the information processing system according to the present disclosure will be described with reference to FIGS. 3 to 6.

### 1.3. Details

FIG. 3 is an explanatory diagram for describing an outline of a calibration process of the information processing system. When the position and orientation of the cinema camera K1 can be expressed in the AR marker coordinate system, it is practically possible to use the position and orientation of the cinema camera K1 in a CG coordinate system. Therefore, as described above, during the VP, the LED panel 10 displays the CG image corresponding to the position and orientation of the cinema camera K1 in the AR marker coordinate system (that is, the CG coordinate system).

In the VP, the CG image is rendered on the basis of the position and orientation of the cinema camera K1 obtained by the tracking system, but in an initial state before the calibration process is performed, the AR marker coordinate system, the coordinate system of the cinema camera K1, and the coordinate system of the tracking camera K2 are independent from each other.

Therefore, in order to reflect the position and orientation of the cinema camera K1 in the CG image, it is necessary to make the AR marker coordinate system, which is the coordinate system attached to the LED panel 10, and the coordinate system of the tracking system internally used by the tracking system common to each other.

In order to make the AR marker coordinate system and the coordinate system of the tracking system common to each other as described above, for example, three independent calibration processes: map generation, mount offset estimation, and LED volume alignment, may be required as an initial configuration.

For example, the calibration of the LED volume alignment makes it possible to unify the coordinate system of the tracking system into the LED panel coordinate system. Furthermore, the mount offset estimation makes it possible to correct a local coordinate system with a coordinate system offset between the cinema camera K1 and the tracking camera K2.

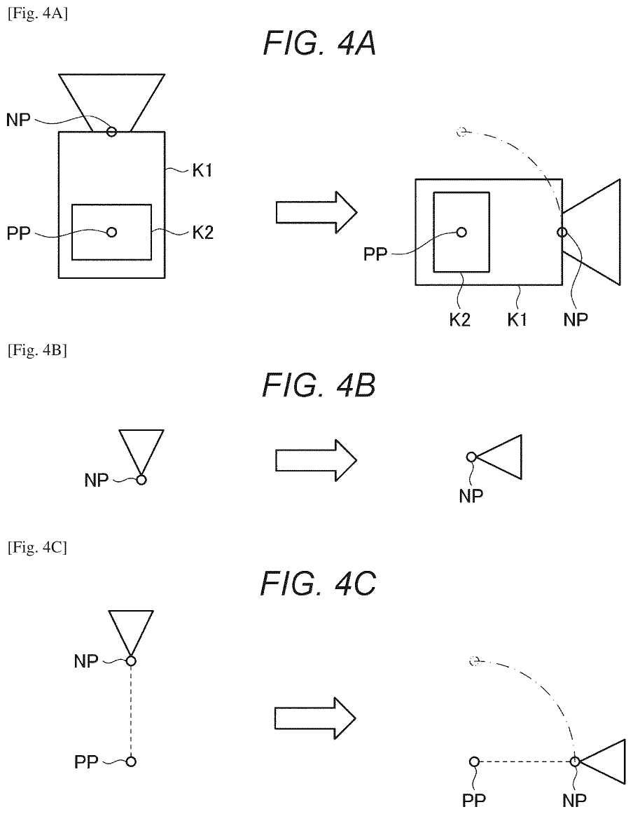

FIGS. 4A to 4C are explanatory diagrams for describing details relating to the correction of the local coordinate system. For example, the user rotates the cinema camera K1 and the tracking camera K2 about a pivot PP (for example, a position where the tracking camera K2 is attached to the cinema camera K1) of the tracking camera K2 as illustrated in FIG. 4A. In this case, an optical center NP of the cinema camera K1 moves in an arc shape as illustrated in the right diagram of FIG. 4A.

Here, when the local coordinate systems of the cinema camera K1 and the tracking camera K2 are different from each other, the optical center NP of the cinema camera K1 is treated as a pure rotation as illustrated in FIG. 4B, which is different from the actual rotation as illustrated in FIG. 4A.

As illustrated in FIG. 4C, in order to move the optical center NP of the cinema camera in an are shape in a manner similar to the actual rotation, it is necessary to convert the local coordinate system by offset correction on the basis of the relative positions of the cinema camera K1 (optical center NP) and the tracking camera K2 (pivot PP).

Such relative positions of the cinema camera K1 and the tracking camera K2 are estimated by the calibration process based on mount offset estimation. The details relating to the correction of the local coordinate system have been described above.

As described above, according to the comparative example, as the initial configuration, the calibration relating to map generation (first process) is first performed, then the calibration relating to mount offset estimation (second process) is performed, and the calibration relating to LED volume alignment (third process) is finally performed. Such calibration processes according to the comparative example, however, have a problem that it takes a lot of time and effort.

It is therefore possible for the information processing apparatus 20 according to the present disclosure to reduce time and effort in calibration. Specifically, the information processing apparatus 20 according to the present disclosure first performs the calibration relating to mount offset estimation by using the AR marker M1 displayed on the LED panel 10, and then simultaneously performs processing corresponding to the calibration relating to map generation and processing corresponding to the calibration relating to LED volume alignment. The use of information regarding such an AR marker M1 makes it possible to reduce time and effort in calibration. Hereinafter, details of each calibration process according to the present disclosure will be sequentially described.

### (Mount Offset Estimation)

The estimation unit 231 according to the present disclosure estimates the relative positions of the cinema camera K1 and the tracking camera K2. For example, the estimation unit 231 may estimate the relative positions of the cinema camera K1 and the tracking camera K2 by Hand-eye calibration.

Specifically, the estimation unit 231 may estimate the relative positions of the cinema camera K1 and the tracking camera K2 using Hand-eye calibration expressed by the following (Expression 1).

$$AX = XB \qquad ( Expression 1 )$$

A: Relative pose of tracking camera K2
B: Relative pose of the cinema camera K1
X: Mount offset

Here, the mount offset X in (Expression 1) corresponds to the relative positions of the cinema camera K1 and the tracking camera K2. That is, the estimation unit 231 may estimate the relative positions of the cinema camera K1 and the tracking camera K2 by obtaining a coordinate transformation matrix of six degrees of freedom using the relative pose of the cinema camera K1 and the relative pose of the tracking camera K2 as input. Note that a technique by which the estimation unit 231 solves H-and-eye calibration is not particularly limited, and a known technique may be used.

Note that Hand-eye calibration may be treated as a robotics problem. In the robotics problem, Hand-eye calibration can be used mainly when a coordinate system of a camera attached to a distal end of a movable arm included in a robot is converted into a coordinate system of the robot. Therefore, the position and orientation of the movable arm change over time, so that an observation point that can be used in coordinate transforrnation estimation is basically only one sample.

On the other hand, the tracking camera K2 according to the present disclosure is attached to the cinema camera K1. That is, since the positional relation between the cinema camera K1 and the tracking camera K2 is fixed, a plurality of samples having different times can be used in coordinate transformation estimation.

Furthermore, in a case where the map generation of the tracking system is not completed, a six-degrees-of-freedom (6DoF) pose of the tracking camera K2 is not obtained from the tracking system, so that it is necessary to obtain the relative pose of the tracking camera K2 from the image data obtained by the tracking camera K2. With such preconditions taken into consideration, a procedure of the calibration relating to mount offset estimation by the estimation unit 231 will be described. In the following description, the image data obtained as a result of capturing an image of the AR marker M1 by the cinema camera K1 may be denoted as an AR marker image, and the image data obtained as a result of capturing an image of the IR marker M2 by the tracking camera K2 may be denoted as an IR marker image.

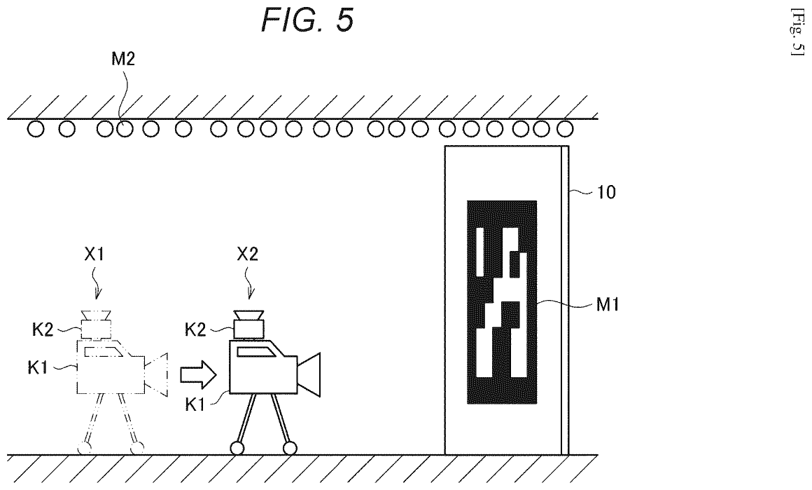

FIG. 5 is an explanatory diagram for describing the procedure of the calibration relating to mount offset estimation. First, at a first position X1, the cinema camera K1 acquires a first AR marker image by capturing an image of the AR marker M1, and the tracking camera K2 acquires a first IR marker image by capturing an image of the IR marker M2.

Then, the user moves the cinema camera K1 and the tracking camera K2 from the first position X1 to a second position X2. For example, the user places the cinema camera K1 and the tracking camera K2 on a dolly and moves the dolly from the first position X1 to the second position X2. Note that the user may rotate the cinema camera K1 and the tracking camera K2 instead of translating the cinema camera K1 and the tracking camera K2, or may not only translate the cinema camera K1 and the tracking camera K2 but also rotate the cinema camera K1 and the tracking camera K2.

Then, at the second position X2, the cinema camera K1 acquires a second AR marker image by capturing an image of the AR marker M1, and the tracking camera K2 acquires a second IR marker image by capturing an image of the IR marker M2.

Here, the estimation unit 231 can estimate the position and orientation of the cinema camera K1 on the basis of the AR marker image obtained as a result of imaging performed by the cinema camera K1. Therefore, the estimation unit 231 estimates the amount of translational movement of the cinema camera K1 and the relative pose of the cinema camera K1 (relative position and orientation of the cinema camera K1 between the first AR marker image and the second AR marker image) on the basis of an image data pair including the first AR marker image and the second AR marker image.

Note that, in order to obtain the mount offset with higher accuracy, the amount of translational movement of the cinema camera K1 is desirably greater than or equal to a predetermined value. Specifically, the amount of translational movement of the cinema camera K1 is desirably greater than or equal to 10% of the installation height of the IR marker M2.

Furthermore, the estimation unit 231 estimates, on the basis of an image data pair including the first IR marker image and the second IR marker image, three-dimensional positions (scale indeterminate) of at least five IR markers M2 included in the image data pair by a five-point algorithm.

Moreover, the user moves the cinema camera K1 and the tracking camera K2 from the second position X2 to a third position (not illustrated).

Next, at the third position, the cinema camera K1 acquires a third AR marker image by capturing an image of the AR marker M1, and the tracking camera K2 acquires a third IR marker image by capturing an image of the IR marker M2.

Then, the estimation unit 231 estimates the amount of translational movement of the cinema camera K1 and the relative pose of the cinema camera K1 (relative position and orientation of the cinema camera K1 between the second AR marker image and the third AR marker image) on the basis of the second AR marker image and the third AR marker image. Note that the amount of translational movement of the cinema camera K1 here is also desirably greater than or equal to the predetermined value.

Furthermore, the estimation unit 231 estimates the relative pose of the tracking camera K2 (relative position and orientation of the tracking camera K2 between the second IR marker image and the third IR marker image) by Perspective-n-Point (PnP) on the basis of an image data pair of the second IR marker image and the third IR marker image and the three-dimensional position of the IR marker M2 estimated by the five-point algorithm.

Then, the estimation unit 231 may estimate the relative positions of the cinema camera K1 and the tracking camera K2 by solving Hand-eye calibration on the basis of a seven-degrees-of-freedom parameter including a six-degrees-of-freedom parameter relating to the positions and orientations of the cinema camera K1 and the tracking camera K2 and a single-degree-of-freedom parameter relating to scale invariance.

Note that, in the above-described example, the example where the cinema camera K1 and the tracking camera K2 obtain three AR marker images and three IR marker images, respectively, and the estimation unit 231 estimates the relative pose of the cinema camera K1 and the relative pose of the tracking camera K2 using two image data pairs for each relative pose has been described. The estimation unit 231, however, may estimate the relative poses of the cinema camera K1 and the tracking camera K2 using four or more pieces of image data (in other words, three or more image data pairs).

For example, the estimation unit 231 may estimate the relative pose of the tracking camera K2 by PnP on the basis of an image data pair including the third IR marker image obtained at the third position and a fourth IR marker image obtained at a fourth position (another position after the cinema camera K1 and the tracking camera K2 are further moved from the third position), and the three-dimensional position of the JR marker M2 estimated by the five-point algorithm. As described above, increasing the number of pieces of image data (in other words, the number of image data pairs) used in estimation of the relative pose of the cinema camera K1 and the relative pose of the tracking camera K2 allows an increase in estimation accuracy of the relative positions of the cinema camera K1 and the tracking camera K2 estimated by Hand-eye calibration.

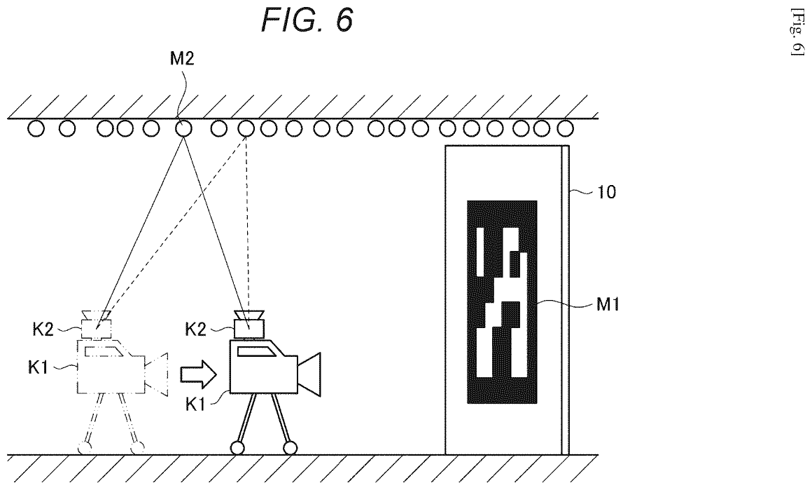

The details of the mount offset estimation according to the present disclosure have been described above. According to the mount offset estimation described above, the relative pose of the cinema camera K1 can be acquired by using the AR marker M1, and it may be possible to simplify the mount offset estimation by applying the relative poses of the cinema camera K1 and the tracking camera K2 to Hand-eye calibration. As a result, it is possible to reduce the burden on the user for calibration. Next, details of processing of generating a map with pose priors including the map generation and the LED volume alignment will be described with reference to FIG. 6.

(Processing of Generating Map with Pose Priors)

### First Method

FIG. 6 is an explanatory diagram for describing an example of processing of generating a map with pose priors. The estimation unit 231 according to the present disclosure estimates position information (position and orientation) of the tracking camera K2 and position information (three-dimensional position) of the IR marker M2 in the AR marker coordinate system on the basis of the AR marker image obtained as a result of capturing an image of the AR marker M1 by the cinema camera K1, the IR marker image obtained as a result of capturing an image of the IR marker M2 by the tracking camera K2, and the relative position information of the cinema camera K1 and the tracking camera K2.

For example, at a certain start point position (for example, a position of the cinema camera K1 and the tracking camera K2 indicated by a long dashed double-short dashed line in FIG. 6), an AR marker image is obtained as a result of imaging performed by the cinema camera K1, and an IR marker image is obtained as a result of imaging performed by the tracking camera K2. Here, the estimation unit 231 estimates the position information of the tracking camera K2 in the AR marker coordinate system at the start point position on the basis of the position information of the cinema camera K1 in the AR marker coordinate system estimated on the basis of the AR marker image and the relative position information of the cinema camera K1 and the tracking camera K2.

Subsequently, the user moves the cinema camera K1 and the tracking camera K2 from the start point position to a post-movement position (for example, a position of the cinema camera K1 and the tracking camera K2 indicated by a solid line in FIG. 6). Then, at the post-movement position, an AR marker image is obtained as a result of imaging performed by the cinema camera K1, and an IR marker image is obtained as a result of imaging performed by the tracking camera K2. Here, the estimation unit 231 estimates the position information of the tracking camera K2 in the A R marker coordinate system at the post-movement position on the basis of the position information of the cinema camera K1 in the AR marker coordinate system estimated on the basis of the AR marker image and the relative position information of the cinema camera K1 and the tracking camera K2.

Then, the estimation unit 231 estimates the amount of relative movement from the start point position to the post-movement position from the estimation results of the position information of the two points of the tracking camera K2 in the AR marker coordinate system.

Furthermore, the estimation unit 231 may estimate, on the basis of the two IR marker images (also referred to as IR marker image pair) obtained at the start point position and the post-movement position and the amount of relative movement made between the images included in the IR marker image pair, the position information of the JR marker M2 included in the IR marker image pair in the AR marker coordinate system.

More specifically, the estimation unit 231 may estimate the position information of the IR marker M2 included in the IR marker image pair by triangulation on the basis of the IR marker image pair obtained at the start point position and the post-movement position and the amount of relative movement made between the images included the IR marker image pair.

Here, since the position and orientation of the tracking camera K2 are estimated in advance in the AR marker coordinate system, the position information of the IR marker M2 estimated by the estimation unit 231 is also estimated as the three-dimensional position of the IR marker M2 in the AR marker coordinate system. That is, the above-described processing of generating a map with pose priors makes it possible to omit the calibration process of the LED volume alignment.

Furthermore, the estimation unit 231 may estimate the amount of relative movement of the tracking camera K2 by PnP on the basis of the three-dimensional position (provisional position) of the IR marker M2 in the AR marker coordinate system. Moreover, the estimation unit 231 may estimate the three-dimensional position of the IR marker M2 in the AR marker coordinate system on the basis of the amount of relative movement of the tracking camera K2 estimated by PnP. As described above, the estimation unit 231 alternately solves triangulation and PnP, so that the three-dimensional position of the IR marker M2 in the AR marker coordinate system can be estimated with higher accuracy.

Note that, in triangulation, the amount of relative movement of the tracking camera K2 obtained by PnP is treated as an input value, and in PnP, the three-dimensional position of the IR marker M2 obtained by triangulation is treated as an input value. Therefore, there is a case where the accuracy of restoration of the three-dimensional position of the IR marker M2 is not improved simply by alternately solving triangulation and PnP. In such a case, the estimation unit 231 may treat the position and orientation of the tracking camera K2 in the AR marker coordinate system as a constraint condition, for example. This allows the estimation unit 231 to estimate the three-dimensional position of the IR marker M2 in the AR marker coordinate system with higher accuracy.

The user moves the cinema camera K1 and the tracking camera K2 to each position in the imaging space, and causes the cinema camera K1 and the tracking camera K2 to capture an image of the AR marker M1 and an image of the IR marker M2 at each position. Then, when the estimation unit 231 repeatedly performs the processing of estimating the three-dimensional position of the IR marker M2, the three-dimensional positions in the AR marker coordinate system of all (or some) of the IR markers M2 arranged on the ceiling in the imaging space can be restored.

Then, the estimation unit 231 may generate map information in the imaging space on the basis of the three-dimensional positions in the AR marker coordinate system of the plurality of IR markers M2 arranged on the ceiling in the imaging space. For example, the estimation unit 231 may generate map information including the three-dimensional positions in the AR marker coordinate system of all (or some) of the IR markers M2 arranged on the ceiling in an imaging environment.

Here, since the positions and orientations of the cinema camera K1 and the tracking camera K2 in the AR marker coordinate system conform to the physical scale, the estimation unit 231 can generate map information with a known scale.

Furthermore, after the estimation unit 231 corrects the scale and performs alignment in the AR marker coordinate system on the basis of the image data pair first obtained by the tracking camera K2, the user may remove the tracking camera K2 from the cinema camera K1. Then, the user may move around the entire imaging space with the removed tracking camera K2. Removing the tracking camera K2 from the cinema camera K1 as described above allows a reduction in weight as compared with a case where both the cinema camera K1 and the tracking camera K2 are moved, and it is therefore possible to further increase user convenience.

### Second Method

In the first method, the example where the estimation unit 231 estimates the three-dimensional position of the IR marker M2 in the AR marker coordinate system by alternately solving triangulation and PnP has been described, but the method by which the estimation unit 231 estimates the three-dimensional position of the IR marker M2 in the AR marker coordinate system is not limited to such an example.

For example, the estimation unit 231 may perform processing relating to known corresponding point search on two pieces of image data obtained as a result of imaging performed by the tracking camera K2, and output information regarding a corresponding point pair (identical IR marker M2) included in each of the two pieces of image data to the storage unit 220.

Next, the estimation unit 231 may estimate the three-dimensional position of the IR marker M2 in the AR marker coordinate system by triangulation on the basis of the new corresponding point pair held in the storage unit 220 and output the estimated position to the storage unit 220.

Moreover, the estimation unit 231 may perform a bundle adjustment as necessary to correct the position and orientation of the tracking camera K2 or the three-dimensional position of the IR marker M2 in the AR marker coordinate system. Note that the bundle adjustment here is optimization processing used to increase the position estimation accuracy, and need not necessarily be performed. Furthermore, the estimation unit 231 may use sensing information obtained by another sensor such as an inertial measurement unit (IMU) as a constraint condition.

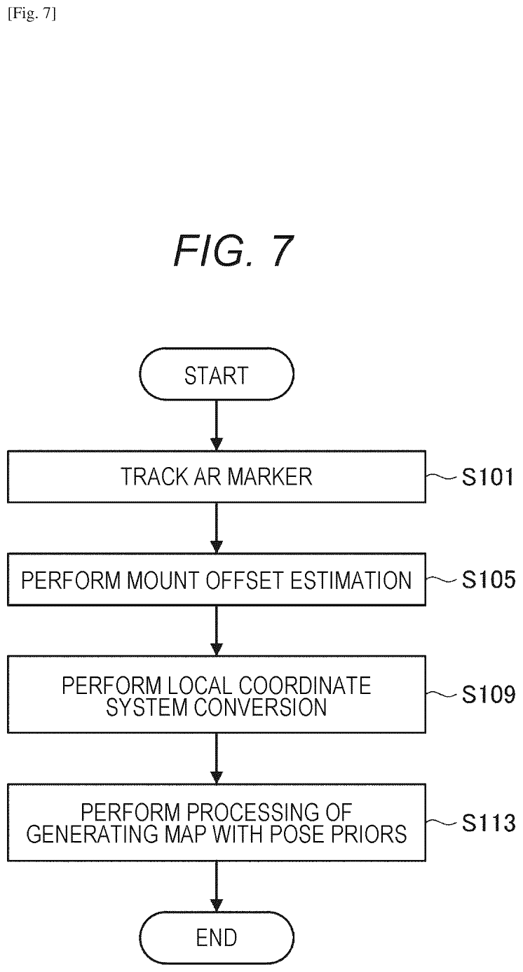

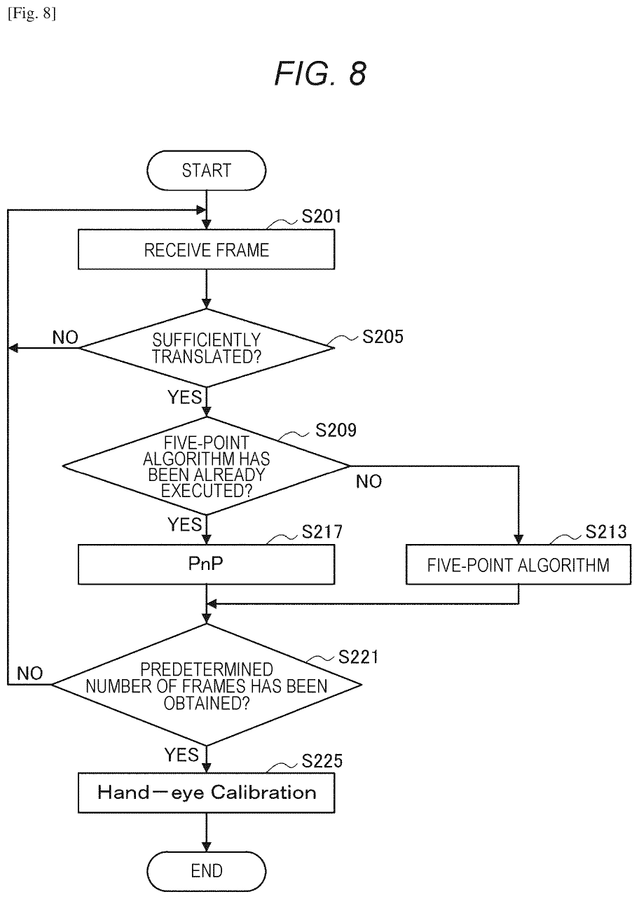

The details of various types of processing performed by the information processing system according to the present disclosure have been described above. As described above, in the information processing system according to the present disclosure, the position and orientation of the cinema camera K1 based on the AR marker M1 displayed on the LED panel 10 is used in estimation of the position information of the tracking camera K2 and the IR marker M2 in the AR marker coordinate system, so that it is possible to reduce work imposed on the user, and it is possible to estimate highly accurate and robust map information. Next, an example of operation processing of the information processing apparatus 20 according to the present disclosure will be described with reference to FIGS. 7 and 8.

### 2. Example of Operation Processing

### (Overall Processing)

FIG. 7 is an explanatory diagram for describing an example of overall processing performed by the information processing apparatus 20 according to the present disclosure. First, the estimation unit 231 tracks the AR marker M1 on the basis of the AR marker image obtained from the cinema camera K1, and estimates the position information of the cinema camera K1 in the AR marker coordinate system (S101).

Next, the estimation unit 231 performs the mount offset estimation on the basis of the AR marker image obtained by the cinema camera K1 and the IR marker image obtained by the tracking camera K2, and acquires the relative position information of the cinema camera K1 and the tracking camera K2 (S105).

Subsequently, the estimation unit 231 performs the processing relating to local coordinate system conversion between the cinema camera K1 and the tracking camera K2 on the basis of the relative position information to make the coordinate system of the tracking camera K2 and the coordinate system of the cinema camera K1 common to each other (S109).

Then, the estimation unit 231 performs the processing of generating a map with pose priors to estimate the position information of the tracking camera K2 and the IR marker M2 in the AR marker coordinate system and generate map information of the imaging space in the AR marker coordinate system on the basis of the estimation result (S113), and the estimation unit 231 according to the present disclosure bring the calibration processing to an end. Next, an example of the mount offset estimation processing in S105 will be described.

### (Mount Offset Estimation)

FIG. 8 is an explanatory diagram for describing an example of the mount offset estimation processing performed by the information processing apparatus 20 according to the present disclosure. First, the communication unit 210 receives the AR marker image from the cinema camera K1 and receives the IR marker image from the tracking camera K2 (S201).

Next, the estimation unit 221 determines whether or not the cinema camera K1 and the tracking camera K2 have sufficiently translated on the basis of the AR marker image (S205). In a case where sufficient translational movement has been performed (S205: Yes), the processing proceeds to S209, and in a case where sufficient translational movement has not been performed (S205: No), the cinema camera K1 and the tracking camera K2 are moved by the user, and the processing returns to S201 again.

Subsequently, the estimation unit 231 determines whether or not the five-point algorithm has been already executed (S209). In a case where the five-point algorithm has not been executed (S209: No), the processing proceeds to S213, and in a case where the five-point algorithm has been already executed (S209: Yes), the processing proceeds to S217.

In a case where the five-point algorithm has not been executed (8209: No), the estimation unit 231 estimates, on the basis of the image data pair including the two IR marker images obtained at the two points, the three-dimensional position of the IR marker M2 included in the image data pair by the five-point algorithm (S213).

In a case where the five-point algorithm has been already executed (S209: Yes), the estimation unit 231 estimates the relative pose of the tracking camera K2 by Perspective-n-Point (PnP) on the basis of the image data pair including the two IR marker images obtained at the two points and the three-dimensional position of the IR marker M2 estimated by the five-point algorithm (S217).

Then, the estimation unit 231 determines whether or not a predetermined number of pieces of image data has been obtained (S221). In a case where the predetermined number of pieces of image data has been obtained (S221: Yes), the processing proceeds to S225, and in a case where the predetermined number of pieces of image data has not been obtained (S221: No), the processing returns to S201 again. Note that the predetermined value here is set to at least 3.

In a case where the predetermined number of pieces of image data has been obtained (S221: Yes), the estimation unit 231 performs Hand-eye calibration on the basis of the relative pose of the cinema camera K1 and the relative pose of the tracking camera K2 to acquire the relative position information of the cinema camera K1 and the tracking camera K2 (S225), and the information processing apparatus 20 according to the present disclosure brings the mount offset estimation processing to an end.

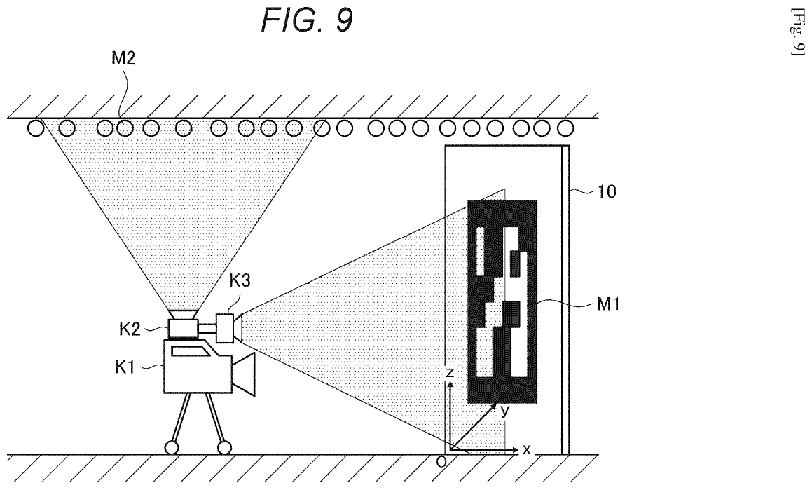

The example of the mount offset estimation processing has been described above. Note that the mount offset estimation according to the present disclosure is not limited to a technique based on Hand-eye calibration. Next, a modification of the information processing system according to the present disclosure will be described with reference to FIG. 9.

### 3. Modification

FIG. 9 is an explanatory diagram for describing the modification of the information processing system according to the present disclosure. A dedicated camera K3 for recognizing the AR marker M1 may be attached in advance to the tracking camera K2 according to the modification. The dedicated camera K3 is an example of a third camera. For example, relative position information of the tracking camera K2 and the dedicated camera K3 may be estimated in advance (for example, before factory shipment), and the storage unit 220 may store the relative position information of the tracking camera K2 and the dedicated camera K3.

As a result, the estimation unit 231 acquires position information of the dedicated camera K3 in the AR marker coordinate system on the basis of an AR marker image obtained as a result of capturing an image of the AR marker M1 by the dedicated camera K3. Moreover, the estimation unit 231 may estimate the position information of the tracking camera K2 in the AR marker coordinate system on the basis of the position information of the dedicated camera K3 in the AR marker coordinate system and the relative position information of the tracking camera K2 and the dedicated camera K3 stored in the storage unit 220.

Then, the estimation unit 231 may estimate the relative position information of the cinema camera K1 and the tracking camera K2 on the basis of the position information of the tracking camera K2 in the AR marker coordinate system and the position information of the cinema camera K1 in the AR marker coordinate system estimated on the basis of the AR marker image obtained as a result of capturing an image of the AR marker M1 by the cinema camera K1.

The dedicated camera K3 for recognizing the AR marker M1 whose position relative to the tracking camera K2 is known is attached to the tracking camera K2 as described above, so that the mount offset estimation by Hand-eye calibration as described above can be omitted.

### 4. Hardware Configuration Example

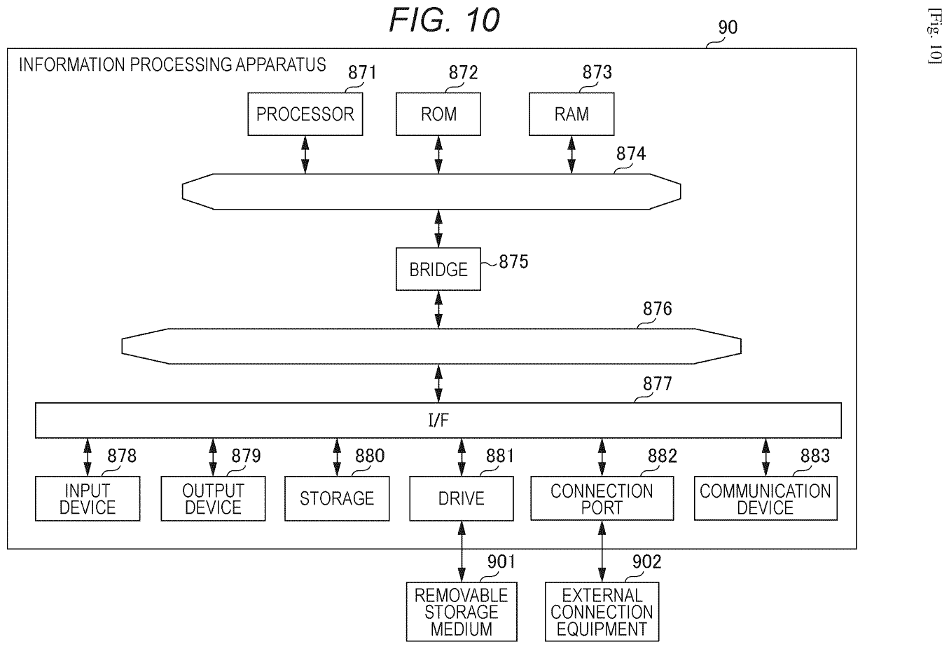

Next, a hardware configuration example of an information processing apparatus 90 according to the embodiment of the present disclosure will be described. FIG. 10 is a block diagram illustrating a hardware configuration example of the information processing apparatus 90 according to the embodiment of the present disclosure. The information processing apparatus 90 may be an apparatus having a hardware configuration equivalent to that of the information processing apparatus 20.

The information processing apparatus 90 includes, for example, a processor 871, a read only memory (ROM) 872, a random access memory (RAM) 873, a host bus 874, a bridge 875, an external bus 876, an interface 877, an input device 878, an output device 879, a storage 880, a drive 881, a connection port 882, and a communication device 883 as illustrated in FIG. 10. Note that, the hardware configuration illustrated here is an example, and some of the components may be omitted. Furthermore, components other than the components illustrated here may be further included.

### (Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

### (ROM 872 and RAM 873)

The ROM 872 is a unit that stores a program read by the processor 871, data used for calculation, or the like. The RAM 873 temporarily or permanently stores, for example, a program read by the processor 871, various parameters that appropriately change when the program is executed, and the like.

### (Host Bus 874, Bridge 875, External Bus 876, and Interface 877)

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

### (Input Device 878)

As the input device 878, for example, a mouse, a keyboard, a touch panel, a button, a switch, a lever, or the like is used. Moreover, as the input device 878, a remote controller (hereinafter referred to as a remote) capable of transmitting a control signal using infrared rays or other radio waves may be used. Furthermore, the input device 878 includes a voice input device such as a microphone.

### (Output Device 879)

The output device 879 is a device capable of visually or audibly notifying the user of acquired information, such as a display device such as a cathode ray tube (CRT), an LCD, or an organic EL, an audio output device such as a speaker or a headphone, a printer, a mobile phone, or a facsimile. Furthermore, the output device 879 according to the present disclosure includes various vibration devices capable of outputting tactile stimulation.

### (Storage 880)

The storage 880 is a device for storing various kinds of data. As the storage 880, for example, a magnetic storage device such as a hard disk drive (HDD), a semiconductor storage device, an optical storage device, a magneto-optical storage device, or the like is used.

### (Drive 881)

The drive 881 is, for example, a device that reads information recorded on the removable storage medium 901 such as a magnetic disk, an optical disc, a magneto-optical disk, or a semiconductor memory, or writes information to the removable storage medium 901.

### (Removable Storage Medium 901)

The removable storage medium 901 is, for example, a DVD medium, a Blu-ray (registered trademark) medium, an HD DVD medium, various semiconductor storage media, or the like. Needless to say, the removable storage medium 901 may be, for example, an IC card on which a non-contact IC chip is mounted, an electronic device, or the like.

### (Connection Port 882)

The connection port 882 is a port for connecting an external connection device 902 such as a universal serial bus (USB) port, an IEEE 1394 port, a small computer system interface (SCSI), an RS-232C port, or an optical audio terminal, for example.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, for example, a wired or wireless LAN, Bluetooth (registered trademark), or a communication card for Wireless USB (WUSB), a router for optical communication, a router for Asymmetric Digital Subscriber Line (ADSL), or a modem for various communications, or the like.

### 5. Conclusion

The preferred embodiment of the present disclosure has been described above in detail with reference to the accompanying drawings, but the technical scope of the present disclosure is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

For example, each step related to the processing described in the present disclosure is not necessarily processed in time series in the order described in the flowchart or the sequence diagram. For example, each step related to the processing of each device may be processed in an order different from the described order or may be processed in parallel.

Furthermore, a series of processing performed by each device described in the present disclosure may be implemented by a program stored in a non-transitory computer readable storage medium. For example, each program is read into the RAM when the computer executes the program, and is executed by a processor such as a CPU. The storage medium is, for example, a magnetic disk, an optical disc, a magneto-optical disk, a flash memory, or the like. Furthermore, the program may be distributed via, for example, a network without using a storage medium.

Furthermore, the effects herein described are merely exemplary or illustrative, and not restrictive. That is, the technology according to the present disclosure may provide other effects described above that are apparent to those skilled in the art from the description of the present specification, in addition to or instead of the effects described above.

(1) An information processing apparatus including:
circuitry configured to
obtain at least one first image of a display screen, the at least one first image being acquired by a first camera,
obtain at least one second image of at least one marker in an imaging space around the display screen, the at least one second image being acquired by a second camera,
estimate first position information of the first camera in relation to the display screen based on the at least one first image,
obtain offset information between the first camera and the second camera, and
estimate second position information of the second camera and third position information of the at least one marker in relation to the display screen based on the first position information, the at least one second image, and the offset information,
wherein a positional relation between the first camera and the second camera is fixed.

(2) The information processing apparatus according to (1), wherein the circuitry is further configured to control output of a display image by the display screen according to a position of the first camera.

(3) The information processing apparatus according to (1) or (2), wherein the circuitry is further configured to control the output of the display image by the display screen during virtual production in which the display image output by the display screen is included in images acquired by the first camera.

(4) The information processing apparatus according to any of (1) to (3), wherein the at least one first image of the display screen includes a display marker.

(5) The information processing apparatus according to any of (1) to (4), wherein the display marker includes an augmented reality marker.

(6) The information processing apparatus according to any of (1) to (5), wherein the display marker is displayed at known coordinates in a coordinate system of the display screen.

(7) The information processing apparatus according to any of (1) to (6), wherein the circuitry is configured to estimate the first position information of the first camera in relation to the display screen using the known coordinates of the display marker.

(8) The information processing apparatus according to any of (1) to (7), wherein the circuitry is further configured to control output of a display image by the display screen according to a position and orientation of the first camera in the coordinate system of the display screen.

(9) The information processing apparatus according to any of (1) to (8), wherein the circuitry is configured to obtain a plurality of first images of the display screen, and wherein the circuitry is configured to obtain a plurality of second images of the at least one marker corresponding to the plurality of first images.

(10) The information processing apparatus according to any of (1) to (9), wherein the plurality of first images of the display screen are acquired by the first camera from a position corresponding to the first position information and the plurality of second images are acquired by the second camera from a position corresponding to the second position information.

(11) The information processing apparatus according to any of (1) to (10), wherein the plurality of first images are acquired by the first camera from a plurality of positions and the plurality of second images are acquired by the second camera from a plurality of positions corresponding to the plurality of positions of the first camera.

(12) The information processing apparatus according to any of (1) to (11), wherein the at least one marker is a retroreflective material, and wherein the second camera is an infrared camera.

(13) The information processing apparatus according to any of (1) to (12), wherein the circuitry is configured to estimate the second position information of the second camera in relation to the display screen based on the first position information and the offset information.

(14) The information processing apparatus according to any of (1) to (13), wherein the circuitry is configured to estimate the third position information of the at least one marker in relation to the display screen based on the at least one second image and the second position information.

(15) The information processing apparatus according to any of (1) to (14), wherein the at least one marker includes a plurality of markers provided around the second camera in the imaging space, and wherein the circuitry is further configured to generate a map of the plurality of markers based on the third position information.

(16) The information processing apparatus according to any of (1) to (15), wherein the obtained offset information is obtained based on predetermined offset information between the second camera and a third camera, and wherein a positional relation between the second camera and the third camera is fixed.

(17) The information processing apparatus according to any of (1) to (16), wherein the circuitry is configured to estimate the offset information by performing calibration based on a plurality of relative poses of the first camera and the second camera.

(18) The information processing apparatus according to any of (1) to (1), wherein the circuitry is configured to estimate the offset information by solving hand-eye calibration based on a seven-degrees-of-freedom parameter including a six-degrees-of-freedom parameter relating to relative positions and orientations of the first camera and the second camera, and a single-degree-of-freedom parameter relating to scale invariance.

(19) An information processing method including:
obtaining at least one first image of a display screen, the at least one first image being acquired by a first camera;
obtaining at least one second image of at least one marker in an imaging space around the display screen, the at least one second image being acquired by a second camera; estimating first position information of the first camera in relation to the display screen based on the at least one first image;
obtaining offset information between the first camera and the second camera; and estimating second position information of the second camera and third position information of the at least one marker in relation to the display screen based on the first position information, the at least one second image, and the offset information, wherein a positional relation between the first camera and the second camera is fixed.

(20) A non-transitory computer-readable medium having embodied thereon a program, which when executed by a computer causes the computer to function as execute an information processing method, the method including:
obtaining at least one first image of a display screen, the at least one first image being acquired by a first camera;
obtaining at least one second image of at least one marker in an imaging space around the display screen, the at least one second image being acquired by a second camera; estimating first position information of the first camera and third position information of the at least one marker in relation to the display screen based on the at least one first image;
obtaining offset information between the first camera and the second camera; and estimating second position information of the second camera and third position information of the at least one marker in relation to the display screen based on the first position information, the at least one second image, and the offset information, wherein a positional relation between the first camera and the second camera is fixed.

(21) An information processing apparatus including:
an acquisition unit that acquires relative position information regarding relative positions of a first camera and a second camera attached to the first camera;
a first estimation unit that estimates position information of the first camera in a coordinate system of a display device arranged in a certain space on the basis of image data obtained as a result of capturing, by the first camera, an image of a first marker displayed by the display device; and
a second estimation unit that estimates position information of a second marker arranged on a wall in the space and position information of the second camera in the coordinate system of the display device on the basis of image data obtained as a result of capturing an image of the second marker by the second camera, the relative position information, and the position information of the first camera in the coordinate system of the display device.

(22) The information processing apparatus according to (21), in which the acquisition unit acquires the relative position information on the basis of a relative pose of the first camera and a relative pose of the second camera.

(23) The information processing apparatus according to (22), in which the relative pose of the first camera is based on at least two image data pairs obtained as a result of capturing, by the first camera, an image of the first marker at at least three positions in the space, and
the relative pose of the second camera is based on at least two image data pairs obtained as a result of capturing, by the second camera, an image of the second marker at positions corresponding to timings at which the first camera captures the image of the first marker.

(24) The information processing apparatus according to (23),
in which the acquisition unit acquires three-dimensional positions of at least five of the second markers on the basis of image data pairs obtained as a result of capturing, by the second camera, an image of the at least five second markers at a first position and a second position in the space, and acquires the relative pose of the second camera on the basis of the three-dimensional positions of the at least five second markers and image data pairs obtained as a result of capturing, by the second camera, an image of the at least five second markers at the second position and a third position in the space.

(25) The information processing apparatus according to (24),
in which the acquisition unit acquires the relative pose of the second camera further on the basis of at least one image data pair obtained as a result of capturing, by the second camera, an image of the at least five second markers at the third position and another position or a plurality of other positions in the space.

(26) The information processing apparatus according to (23),
in which the first marker is an AR marker whose coordinate value is defined in the coordinate system of the display device.

(27) The information processing apparatus according to (23),
in which the acquisition unit acquires the relative position information on the basis of a seven-degrees-of-freedom parameter including a six-degrees-of-freedom parameter relating to a position and orientation and a single-degree-of-freedom parameter relating to scale invariance.

(28) The information processing apparatus according to (2¹),
in which the acquisition unit acquires the relative position information regarding the relative positions of the first camera and the second camera on the basis of image data obtained as a result of capturing an image of the first marker by a third camera that is attached to the second camera in advance and has a relative positional relation with the second camera registered in advance.

(29) The information processing apparatus according to any one of (21) to (28), in which the second estimation unit estimates the position information of the second camera in the coordinate system of the display device on the basis of the position information of the first camera in the coordinate system of the display device and the relative position information, and estimates, on the basis of the position information of the second camera in the coordinate system of the display device and an image data pair obtained as a result of imaging performed by the second camera, the position information in the coordinate system of the display device of the second marker included in the image data pair.

(30) The information processing apparatus according to (29),
in which the second estimation unit estimates the position information of the second marker in the coordinate system of the display device on the basis of an image data pair obtained as a result of imaging performed by the second camera at different positions in the space.

(31) The information processing apparatus according to (30),
in which the second estimation unit estimates provisional position information of the second marker in the coordinate system of the display device on the basis of an image data pair obtained as a result of imaging performed by the second camera at different positions in the space, estimates an amount of relative movement of the second camera on the basis of the provisional position information, and estimates the position information of the second marker in the coordinate system of the display device on the basis of the amount of relative movement.

(32) The information processing apparatus according to any one of (21) to (28),
in which the second estimation unit performs processing relating to corresponding point search on an image data pair obtained as a result of imaging performed by the second camera at different positions in the space, estimates a corresponding point pair indicating an identical second marker included in each of two pieces of image data included in the image data pair, and estimates the position information of the second marker in the coordinate system of the display device on the basis of the corresponding point pair.

(33) The information processing apparatus according to any one of (21) to (32),
in which the second estimation unit estimates map information in the space on the basis of position information in the coordinate system of the display device of a plurality of the second markers arranged in the space.

(34) The information processing apparatus according to any one of (21) to (33),
in which the second marker includes a retroreflective marker.

(35) An information processing method executed by a computer, the information processing method including:
acquiring relative position information regarding relative positions of a first camera and a second camera attached to the first camera;
estimating position information of the first camera in a coordinate system of a display device arranged in a certain space on the basis of image data obtained as a result of capturing, by the first camera, an image of a first marker displayed by the display device; and
estimating position information of a second marker arranged on a wall in the space and position information of the second camera in the coordinate system of the display device on the basis of image data obtained as a result of capturing an image of the second marker by the second camera, the relative position information, and the position information of the first camera in the coordinate system of the display device.

(36) A program causing a computer to function as an information processing apparatus, the information processing apparatus including:
an acquisition unit that acquires relative position information regarding relative positions of a first camera and a second camera attached to the first camera;
a first estimation unit that estimates position information of the first camera in a coordinate system of a display device arranged in a certain space on the basis of image data obtained as a result of capturing, by the first camera, an image of a first marker displayed by the display device; and
a second estimation unit that estimates position information of a second marker arranged on a wall in the space and position information of the second camera in the coordinate system of the display device on the basis of image data obtained as a result of capturing an image of the second marker by the second camera, the relative position information, and the position information of the first camera in the coordinate system of the display device.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 LED panel
20 Information processing apparatus
21 Display unit
210 Communication unit
220 Storage unit
230 Control unit
231 Estimation unit
K1 Cinema camera
K2 Tracking camera
K3 Dedicated camera
M1 AR marker
M2 IR marker

1. An information processing apparatus comprising:
circuitry configured to
obtain at least one first image of a display screen, the at least one first image being acquired by a first camera,
obtain at least one second image of at least one marker in an imaging space around the display screen, the at least one second image being acquired by a second camera,
estimate first position information of the first camera in relation to the display screen based on the at least one first image,
obtain offset information between the first camera and the second camera, and
estimate second position information of the second camera and third position information of the at least one marker in relation to the display screen based on the first position information, the at least one second image, and the offset information,
wherein a positional relation between the first camera and the second camera is fixed.

2. The information processing apparatus according to claim 1,
wherein the circuitry is further configured to control output of a display image by the display screen according to a position of the first camera.

3. The information processing apparatus according to claim 2,
wherein the circuitry is further configured to control the output of the display image by the display screen during virtual production in which the display image output by the display screen is included in images acquired by the first camera.

4. The information processing apparatus according to claim 1,
wherein the at least one first image of the display screen includes a display marker.

5. The information processing apparatus according to claim 4,
wherein the display marker includes an augmented reality marker.

6. The information processing apparatus according to claim 4,
wherein the display marker is displayed at known coordinates in a coordinate system of the display screen.

7. The information processing apparatus according to claim 6,
wherein the circuitry is configured to estimate the first position information of the first camera in relation to the display screen using the known coordinates of the display marker.

8. The information processing apparatus according to claim 6,
wherein the circuitry is further configured to control output of a display image by the display screen according to a position and orientation of the first camera in the coordinate system of the display screen.

9. The information processing apparatus according to claim 1,
wherein the circuitry is configured to obtain a plurality of first images of the display screen, and
wherein the circuitry is configured to obtain a plurality of second images of the at least one marker corresponding to the plurality of first images.

10. The information processing apparatus according to claim 9,
wherein the plurality of first images of the display screen are acquired by the first camera from a position corresponding to the first position information and the plurality of second images are acquired by the second camera from a position corresponding to the second position information.

11. The information processing apparatus according to claim 9,
wherein the plurality of first images are acquired by the first camera from a plurality of positions and the plurality of second images are acquired by the second camera from a plurality of positions corresponding to the plurality of positions of the first camera.

12. The information processing apparatus according to claim 1,
wherein the at least one marker is a retroreflective material, and
wherein the second camera is an infrared camera.

13. The information processing apparatus according to claim 1,
wherein the circuitry is configured to estimate the second position information of the second camera in relation to the display screen based on the first position information and the offset information.

14. The information processing apparatus according to claim 13,
wherein the circuitry is configured to estimate the third position information of the at least one marker in relation to the display screen based on the at least one second image and the second position information.

15. The information processing apparatus according to claim 14,
wherein the at least one marker includes a plurality of markers provided around the second camera in the imaging space, and
wherein the circuitry is further configured to generate a map of the plurality of markers based on the third position information.

16. The information processing apparatus according to claim 1,
wherein the obtained offset information is obtained based on predetermined offset information between the second camera and a third camera, and
wherein a positional relation between the second camera and the third camera is fixed.

17. The information processing apparatus according to claim 1,
wherein the circuitry is configured to estimate the offset information by performing calibration based on a plurality of relative poses of the first camera and the second camera.

18. The information processing apparatus according to claim 1,
wherein the circuitry is configured to estimate the offset information by solving hand-eye calibration based on a seven-degrees-of-freedom parameter including
a six-degrees-of-freedom parameter relating to relative positions and orientations of the first camera and the second camera, and
a single-degree-of-freedom parameter relating to scale invariance.

19. An information processing method comprising:
obtaining at least one first image of a display screen, the at least one first image being acquired by a first camera;
obtaining at least one second image of at least one marker in an imaging space around the display screen, the at least one second image being acquired by a second camera;
estimating first position information of the first camera in relation to the display screen based on the at least one first image;
obtaining offset information between the first camera and the second camera; and
estimating second position information of the second camera and third position information of the at least one marker in relation to the display screen based on the first position information, the at least one second image, and the offset information,
wherein a positional relation between the first camera and the second camera is fixed.

20. A non-transitory computer-readable medium having embodied thereon a program, which when executed by a computer causes the computer to function as execute an information processing method, the method comprising:
obtaining at least one first image of a display screen, the at least one first image being acquired by a first camera;
obtaining at least one second image of at least one marker in an imaging space around the display screen, the at least one second image being acquired by a second camera;
estimating first position information of the first camera and third position information of the at least one marker in relation to the display screen based on the at least one first image;
obtaining offset information between the first camera and the second camera; and
estimating second position information of the second camera and third position information of the at least one marker in relation to the display screen based on the first position information, the at least one second image, and the offset information,
wherein a positional relation between the first camera and the second camera is fixed.
